(19) United States
(12) Patent Application Publication
(10) Pub. No.: US 2024/0287966 A1
(43) Pub. Date: Aug. 29, 2024

(54) METHOD AND DEVICE FOR CONTROLLING WIND SPEED PARAMETER OF WIND-BASED POWER GENERATION FACILITY

(71) Applicant: DXLABZ Co., Ltd., Suwon-si (KR)

(72) Inventors: Jong Hyun KIM, Sejong-si (KR); Myoung Cheol KANG, Daejeon (KR); Chae Young Park, Jinju-si (KR); Jun Young JEONG, Jinju-si (KR); Jin Won LEE, Jinju-si (KR)

(73) Assignee: DXLABZ Co., Ltd., Suwon-si (KR)

(21) Appl. No.: 18/583,220

(22) Filed: Feb. 21, 2024

(30) Foreign Application Priority Data
Feb. 23, 2023 (KR) 10-2023-0024289

(51) Int. Cl. F03D 7/02; F03D 7/04; G05B 17/02

(52) U.S. Cl. CPC F03D 7/028; F03D 7/045; G05B 17/02; F05B 2270/32

(57) ABSTRACT

Provided are a method and device for controlling a wind speed parameter of a wind-based power generation facility which include a memory; and a processor connected to the memory, wherein the processor is configured to: receive a first wind speed corresponding to an average wind speed per a preset time interval from a first real-world wind-based power generation facility installed in a real world, and receive therefrom a first power generation amount as generated per the preset time interval; generate a first dataset representing a power generation amount based on a change in a wind speed, based on the first wind speed and the first power generation amount; calculate a first power coefficient related to the first power generation amount based on each first wind speed, based on the first data set.

### CROSS-REFERENCE TO RELATED APPLICATION

This application claims priority to and the benefit of Korean Patent Application No. 2023-0024289, filed on Feb. 23, 2023, the disclosure of which is incorporated herein by reference in its entirety.

### BACKGROUND OF THE DISCLOSURE

### 1. Field of the Disclosure

The present disclosure relates to a method and device for controlling a wind speed parameter of a wind-based power generation facility.

### 2. Description of the Related Art

The present disclosure has been derived as a portion of a research project (project number 20223030020180).

Unless otherwise indicated in the present disclosure, a material described in this section is not a prior art to the claims of the present application, and inclusion of the material in this section does not admit that the material constitutes the prior art.

Digital twin is a technology that creates a twin of a real object in a computer and predicts the result in advance by simulating situations that may occur in the real world with the computer.

This digital twin technology is applied to a wind-based power generation facility to predict a power generation amount thereof, and predict damage thereto to ensure smooth management.

However, when, in order to derive the power generation amount of the wind-based power generation facility, a wind speed measured in a real word is input to a wind-based power generation facility implemented based on the digital twin, a difference between an actual power generation amount and a predicted power generation amount may occur.

For this reason, in accordance with the present disclosure, a technology for correcting a wind speed parameter such that the power generation amount of the real-world wind-based power generation facility and the power generation amount of the wind-based power generation facility implemented based on the digital twin may be simulated identically.

### SUMMARY OF THE DISCLOSURE

A purpose of one embodiment of the present disclosure is to provide a method and device for controlling the wind speed parameter of the wind-based power generation facility.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means illustrated in the claims and combinations thereof.

In order to achieve the above purpose, an electronic device according to one embodiment of the present disclosure includes a memory; and a processor connected to the memory, wherein the processor is configured to: receive a first wind speed corresponding to an average wind speed per a preset time interval from a first real-world wind-based power generation facility installed in a real world, and receive therefrom a first power generation amount as generated per the preset time interval; generate a first dataset representing a power generation amount based on a change in a wind speed, based on the first wind speed and the first power generation amount; calculate a first power coefficient related to the first power generation amount based on each first wind speed, based on the first data set; derive an initial wind speed weight based on a digital twin (DT) of another real-world wind-based power generation facility having similar external and internal environments to external and internal environments of the first real-world wind-based power generation facility; apply a wind speed weight to which the initial wind speed weight has been applied to the first wind speed to derive a second wind speed to be applied to the digital twin (DT); apply the second wind speed to a DT-based wind-based power generation facility model implemented using the digital twin (DT) to derive a second power generation amount based on the second wind speed, and then generate a second dataset representing a power generation amount based on a change in a wind speed, based on the second wind speed and the second power generation amount; calculate a second power coefficient related to the second power generation amount based on each second wind speed, based on the second data set; and adjust the wind speed weight based on a comparing result between the first power coefficient and the second power coefficient.

In one implementation, the processor may be configured to derive the second wind speed by applying the wind speed weight and a vertical component of the wind speed to the first wind speed.

In one implementation, the processor may be configured to derive the second wind speed based on a following Mathematical Equation 1:

$$WS\_ 2 = WS\_ 1 \times ( 1 + \frac{\vert cos ( θ ) \vert}{WoWS} ) \qquad [ Mathematical Equation 1 ]$$

where WS (Wind Speed)_2 means the second wind speed, WS_1 means the first wind speed, θ means an angle of a wind direction of the first wind speed relative to a preset wind receiving direction of the wind-based power generation facility, and WoWS (Weight of Wind Speed) means the wind speed weight.

In this regard, the first power coefficient may be calculated based on a following Mathematical Equation 2:

$$CP\_ 1 = \frac{P\_ 1}{( \frac{1}{2} \cdot ρ \cdot A \cdot WS\_ {1}^{3} )} \qquad [ Mathematical Equation 2 ]$$

where CP(Power coefficient)_1 means the first power coefficient, P_1 means the first power generation amount, p means a preset air density, A refers to a cross-sectional area size of a rotor of the first real-world wind-based power generation facility in contact with air, and WS(Wind Speed)_1 means the first wind speed.

Moreover, the second power coefficient may be calculated based on a following Mathematical Equation 3:

$$CP\_ 2 = \frac{P\_ 2}{( \frac{1}{2} \cdot ρ \cdot A \cdot WS\_ {2}^{3} )} \qquad [ Mathmematical Equation 3 ]$$

where CP_2 means the second power coefficient, P_2 means the second power generation amount, p means the preset air density, A refers to a cross-sectional area size of a rotor of the DT-based wind-based power generation facility in contact with air, and WS(Wind Speed)_2 means the second wind speed.

In one implementation, the processor may be configured to: derive a first maximum power coefficient with a highest value from among the first power coefficients derived respectively based on the first wind speeds; derive a second maximum power coefficient with a highest value from among the second power coefficients derived respectively based on the second wind speeds; and derive a wind speed weight at which the first maximum power coefficient and the second maximum power coefficient are equal to each other as a first final wind speed weight.

In one implementation, the processor may be further configured to: receive first external environmental information regarding an above sea level and an average regional wind speed during a preset period at a location where the first real-world wind-based power generation facility is installed; receive first internal environmental information regarding a maximum power generation capacity, a number of blades, and a rotor area size of the first real-world wind-based power generation facility; receive second external environmental information regarding an above sea level and an average regional wind speed during a preset period at a location where a second real-world wind-based power generation facility other than the first real-world wind-based power generation facility is installed; receive second internal environmental information regarding a maximum power generation capacity, a number of blades, and a rotor area size of the second real-world wind-based power generation facility; compare the first and second external environment information with each other and the first and second internal environment information with each other; derive a similarity between the first real-world wind-based power generation facility and the second real-world wind-based power generation facility based on the comparing result; compare the derived similarity with a preset threshold similarity and derive a third real-world wind-based power generation facility having a similarity exceeding the threshold similarity; and derive the initial wind speed weight to be initially applied as an average value of a second final wind speed weight of the third real-world wind-based power generation facility.

In one implementation, the processor may be further configured to normalize each of the factors included in the first external environment information, the first internal environment information, the second external environment information, and the second internal environment information to a preset numerical range; round the normalized value of each factor to convert the same into an integer; generate a first vector value based on the integer value of each factor of the first real-world wind-based power generation facility; generate a second vector value based on the integer value of each factor of the second real-world wind-based power generation facility; and derive the similarity based on the first vector value and the second vector value.

In one implementation, the processor may be further configured to calculate the similarity based on following Mathematical Equation 4:

$$Similarity = \frac{{\sum }_{i = 1}^{k} ( VV1\_i \cdot VV2\_i )}{\sqrt{{\sum }_{i = 1}^{k} {VV1\_i}^{2}} \cdot \sqrt{{\sum }_{i = 1}^{k} VV 2 {\_i}^{2}}} \qquad [ Mathematical Equation 4 ]$$

where VV (Vector Value)1_i refers to an integer value of an i-th factor in the first vector value, VV2_i means an integer value of an i-th factor in the second vector value, and k means the number of factors.

Thus, according to an embodiment of the present disclosure, the device and method for correcting the wind speed parameters of the wind-based power generation facility for digital twin implementation may be provided.

Effects of the present disclosure are not limited to the effects mentioned above, and other effects not mentioned will be clearly understood by those skilled in the art from the descriptions below.

### BRIEF DESCRIPTION OF THE DRAWINGS

Further aspects, features and benefits as described above of certain preferred embodiments of the present disclosure will become more apparent from the following description taken in conjunction with the accompanying drawings.

FIG. 1 is a conceptual diagram of a device for controlling a wind speed parameter of a wind-based power generation facility according to an embodiment of the present disclosure.

FIG. 2 is a block diagram of an electronic device according to an embodiment of the present disclosure.

FIG. 3 is a comparison diagram of a power curve according to wind speed correction according to an embodiment of the present disclosure.

FIG. 4 is a conceptual diagram determining a vertical component of a wind according to an embodiment of the present disclosure.

FIG. 5 is a diagram showing a comparison of power coefficients according to one embodiment of the present disclosure.

FIG. 6 is a diagram showing a concept of internal and external environmental information of a real-world wind-based power generation facility according to an embodiment of the present disclosure.

FIG. 7 is a diagram showing derivation of a vector value for determining a similarity according to an embodiment of the present disclosure.

FIG. 8 is a flowchart of a method for controlling a wind speed parameter of a wind-based power generation facility according to an embodiment of the present disclosure.

It should be noted that throughout the drawings, like reference numerals are used to illustrate identical or similar elements, features and structures.

### DETAILED DESCRIPTION OF THE DISCLOSURE

Hereinafter, embodiments of the present disclosure will be described in detail with reference to the attached drawings.

When describing an embodiment, the description of technical contents that are well known in the technical field to which the present disclosure belongs and that is not directly related to the present disclosure is omitted. This is to convey the gist of the present disclosure more clearly without obscuring the gist by omitting unnecessary descriptions.

For the same reason, some components are exaggerated, omitted, or schematically shown in the accompanying drawings. Moreover, a size of each component does not correspond to an actual size. In each drawing, identical or corresponding components are assigned the same reference numbers.

The advantages and features of the present disclosure, and a method to achieve them will become clear by referring to the embodiments as described in detail below along with the accompanying drawings. However, the present disclosure is not limited to the embodiments disclosed below and may be implemented in various different forms. These embodiments are provided to only ensure that the present disclosure is complete, and to fully inform those skilled in the art of the present disclosure of the scope of the present disclosure, and the present disclosure is only defined by the scope of the claims. Like reference numerals refer to like elements throughout the specification.

In this regard, it will be understood that blocks of process flowcharts and combinations of the process flowcharts may be performed based on computer program instructions. These computer program instructions may be installed on a processor of a general-purpose computer, special-purpose computer, or other programmable data processing device. Thus, the instructions as executed by a processor in a computer or other programmable data processing device may create a means of performing the functions described in the flowchart block(s). These computer program instructions may also be stored in a computer-usable or computer-readable memory that may be directed to a computer or other programmable data processing device to implement a function in a particular manner. Thus, the instructions stored in the computer-usable or computer-readable memory may be capable of producing a manufacture article containing instruction means to perform the functions described in the flow diagram block(s). The computer program instructions may also be installed on a computer or other programmable data processing device. Thus, the instructions may create a computer-executed process in which a series of operational steps is performed on a computer or other programmable data processing device to execute the computer or other programmable data processing device may provide steps for executing the functions described in the flowchart block(s).

Moreover, each block may represent a portion of a module, a segment, or a code containing one or more executable instructions for executing specified logical function(s). Additionally, it should be noted that in some alternative execution examples, the functions mentioned in the blocks may be executed out of the order indicated in some examples. For example, two blocks shown in succession may be performed substantially at the same time, or may performed in a reverse order thereto depending on corresponding functions thereto.

In this regard, the term ‘˜unit’ used in this embodiment refers to software or hardware component such as FPGA (field-programmable gate array) or ASIC (Application Specific Integrated Circuit), and ‘˜unit’ may perform a specific function. However, ‘˜unit’ is not limited to the software or hardware implementation. ‘˜unit’ may be configured to reside in an addressable storage medium or may be configured to reproduce one or more processors. Therefore, in an example, ‘˜unit’ includes components such as software components, object-oriented software components, class components, and task components, processes, functions, properties, procedures, subroutines, segments of program codes, drivers, firmware, microcode, circuits, data, databases, data structures, tables, arrays, and variables. The functions provided within the components and ‘˜units’ may be combined into a smaller number of components and ‘˜units’ or may be further divided into additional components and ‘˜units’. Additionally, the components and ‘˜units’ may be implemented to reproduce one or more CPUs within the device or secure multimedia card.

In describing embodiments of the present disclosure in detail, the description will be mainly based on an example of a specific system. However, the main point sought to be claimed in the present disclosure is also applicable to other communication systems and services with similar technical backgrounds to the extent that it does not significantly deviate from the scope disclosed in the present disclosure. This may be up to the discretion of a person with skilled technical knowledge in the relevant technical field.

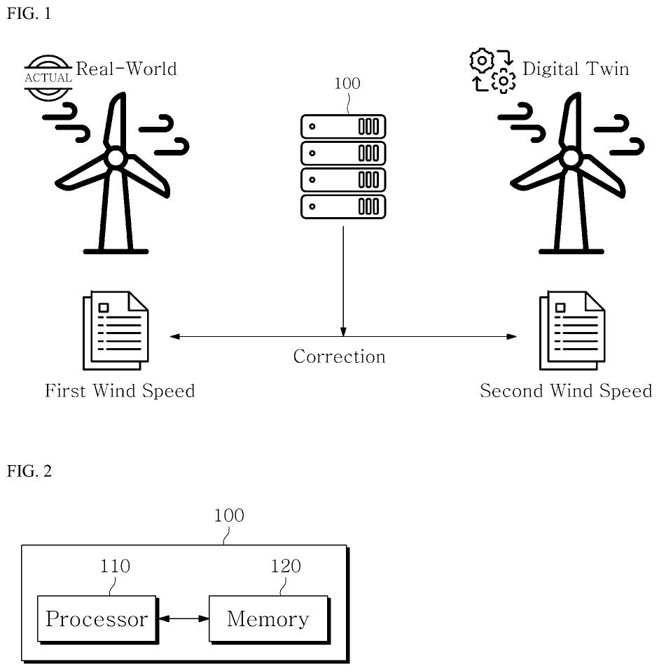

FIG. 1 is a conceptual diagram of a device for controlling a wind speed parameter of a wind-based power generation facility according to an embodiment of the present disclosure.

Referring to FIG. 1, a device for controlling the wind speed parameter of the wind-based power generation facility according to an embodiment of the present disclosure may be configured to correct the wind speed so as to derive the power generation amount equal to that of a real-world wind-based power generation facility based on a real-world wind speed.

In one example, the device for controlling the wind speed parameter of the wind-based power generation facility may be referred to as an ‘electronic device 100’ in the present disclosure.

FIG. 2 is a block diagram of the electronic device 100 according to an embodiment of the present disclosure.

The electronic device 100 according to one embodiment includes a processor 110 and a memory 120. The processor 110 may perform at least one of methods as described above. The memory 120 may store therein information related to the above-described method or store therein a program for implementing the above-described method. The memory 120 may be a volatile memory or non-volatile memory. The memory 120 may be referred to as a ‘database’, a ‘storage unit’, etc.

The processor 110 executes a program. The electronic device 100 may be controlled by the processor 110. The code of the program executed by the processor 110 may be stored in the memory 120. The device 100 may be connected to an external device (e.g., a personal computer or a network) through an input/output device (not shown) and may exchange data therewith.

In this regard, the processor 110 may receive a first wind speed corresponding to an average wind speed per a preset time interval from a first real-world wind-based power generation facility installed in a real world, and may receive therefrom a first power generation amount as generated per the preset time interval.

In this regard, the real-world wind-based power generation facility may refer to any apparatus that generates power through the wind power.

The preset time interval may be arbitrarily set by an operator of the device according to the present disclosure. For example, the time interval may be set to 10 minutes.

Moreover, the first wind speed may be set to an average value of the wind speed measured during the time interval.

Moreover, the first power generation amount may mean an amount of the power generated during the time interval.

Moreover, the processor 110 may generate a first dataset representing a power generation amount based on a change in the wind speed based on the first wind speed and the first power generation amount.

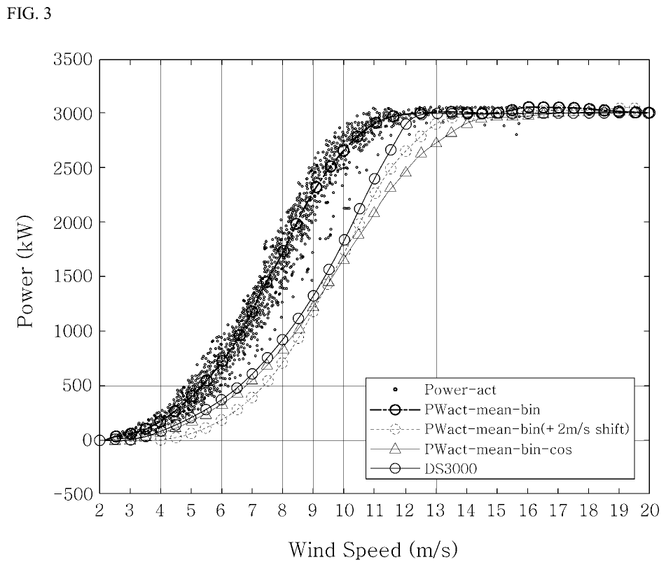

In this regard, the first dataset may be created in a form of a graph showing a relationship between the wind speed and the power generation amount, as shown in FIG. 3.

Moreover, the processor 110 may calculate a first power coefficient related to the first power generation amount based on each first wind speed, based on the first data set.

In this regard, the power coefficient relates to a ratio between an expected power generation amount based on the specifications of the wind-based power generation facility and an actual power generation amount thereof. This will be described later.

Moreover, the processor 110 may derive an initial wind speed weight based on a digital twin of another real-world wind-based power generation facility having similar external and internal environments to those of the first real-world wind-based power generation facility. In this regard, the derivation of the initial wind speed weight will be described in more detail later.

Moreover, the processor 110 may apply a wind speed weight to which the initial wind speed weight has been applied to the first wind speed to derive a second wind speed for application to the digital twin (DT).

As described above, when the wind speed measured in the real world is directly input to the wind-based power generation facility implemented based on the digital twin, a difference occurs with the actual power generation amount and the power generation amount as predicted based on the DT.

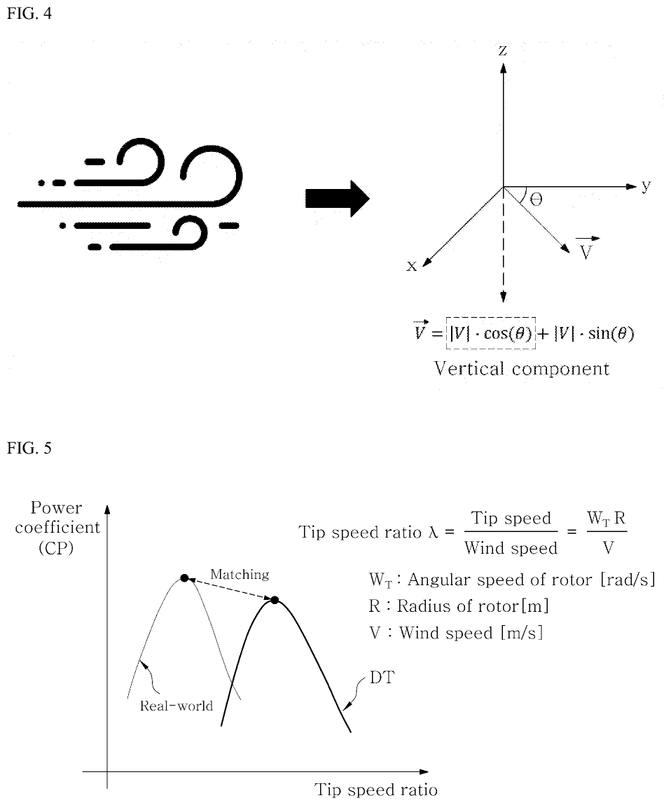

This is because, as shown in FIG. 4, the wind includes horizontal and vertical components.

Therefore, in order that the vertical component of the wind may be considered in the digital twin, the processor 110 may derive the second wind speed by applying the wind speed weight and the vertical component of the wind speed to the first wind speed.

In more detail, the second wind speed may be derived based on a following Mathematical Equation 1:

$$WS\_ 2 = WS\_ 1 \times ( 1 + \frac{\vert cos ( θ ) \vert}{WoWS} ) \qquad [ Mathematical Equation 1 ]$$

where WS (Wind Speed)_2 means the second wind speed, WS_1 means the first wind speed, θ refers to an angle of a wind direction of the first wind speed relative to a preset wind receiving direction of the wind-based power generation facility, and WoWS (Weight of Wind Speed) refers to the wind speed weight.

In this regard, the wind speed weight plays a role in matching the real-world wind speed and a wind speed based on the DT with each other, as will be described later. In this regard, the initial wind speed weight is required for the implementation of the present disclosure, and may be arbitrarily set by the operator of the device of the present disclosure, or may be set to an average value of a final wind speed weight derived from another real wind-based power generation facility with similar external and internal environments as those of the real-world wind-based power generation facility to which the present disclosure will be applied. This will be described in more detail later.

Moreover, the processor 110 may apply the second wind speed to a DT-based wind-based power generation facility model implemented using the digital twin (DT) to derive a second power generation amount based on the second wind speed. Then, the processor 110 may create a second dataset representing the power generation amount based on the change in the wind speed, based on the second wind speed and the second power generation amount.

In this regard, the DT-based wind-based power generation facility model may mean a model as obtained by implementing the real-world wind-based power generation facility on a computer. In more detail, the DT-based wind-based power generation facility model may mean a virtual wind-based power generation facility model having specifications identical to the specifications of the real-world wind-based power generation facility on a simulation in which the same physical engine as a real-world physical engine is implemented.

In this regard, the second dataset may be created in a form of a graph showing a relationship between a wind speed and a power generation amount, as shown in FIG. 3.

Moreover, the processor 110 may calculate the second power coefficient related to the second power generation amount based on each second wind speed, based on the second data set.

Moreover, the processor 110 may adjust the wind speed weight based on a comparing result between the first power coefficient and the second power coefficient.

FIG. 5 is a diagram showing a comparison of power coefficients according to one embodiment of the present disclosure.

FIG. 5 shows a relationship between the power coefficient and a tip speed ratio. In more detail, the tip speed ratio refers to a ratio of a tip speed and a wind speed. A large tip speed ratio means that an amount of energy that the wind transfers to a blade is large. In this regard, the tip speed refers to a speed of a tip of the blade. A difference between the first power coefficient and the second power coefficient only depends on a difference in the wind speed according to a formula in FIG. 5. Thus, ultimately, a relationship between the wind speed and the power coefficient may be the same as the relationship between the power coefficient and the tip speed ratio (in a left and right inverted manner).

In this regard, the first power coefficient may be calculated based on a following Mathematical Equation 2:

$$CP\_ 1 = \frac{P\_ 1}{( \frac{1}{2} \cdot ρ \cdot A \cdot WS\_ {1}^{3} )} \qquad [ Mathematical Equation 2 ]$$

where CP(Power coefficient)_1 means the first power coefficient, P_1 means the first power generation amount, p means a preset air density, A refers to a cross-sectional area size of a rotor of the first real-world wind-based power generation facility in contact with air, and WS(Wind Speed)_1 means the first wind speed.

Moreover, the second power coefficient may be calculated based on a following Mathematical Equation 3:

$$CP\_ 2 = \frac{P\_ 2}{( \frac{1}{2} \cdot ρ \cdot A \cdot WS\_ {2}^{3} )} \qquad [ Mathmematical Equation 3 ]$$

where CP_2 means the second power coefficient, P_2 means the second power generation amount, p means the preset air density, A refers to a cross-sectional area size of a rotor of the DT-based wind-based power generation facility in contact with air, and WS(Wind Speed)_2 means the second wind speed.

In this regard, each of the air density and the cross-sectional area size of the rotor may be applied equally to the real-world wind-based power generation facility and the DT-based wind-based power generation facility. Each of the air density and the cross-sectional area size of the rotor may be set to the same value in the Mathematical Equations 2 and 3.

In this regard, in order to match the first power coefficient and the second power coefficient with each other, the processor 110 may derive a first maximum power coefficient with the highest value from among the first power coefficients derived respectively based on the first wind speeds, and may derive a second maximum power coefficient with the highest value from among the second power coefficients derived respectively based on the second wind speeds. Then, the processor 110 may derive a wind speed weight at which the first maximum power coefficient and the second maximum power coefficient are equal to each other as a first final wind speed weight.

In this way, the wind speed may be corrected so that the same power generation amount is obtained when implementing the real-world wind speed on the digital twin.

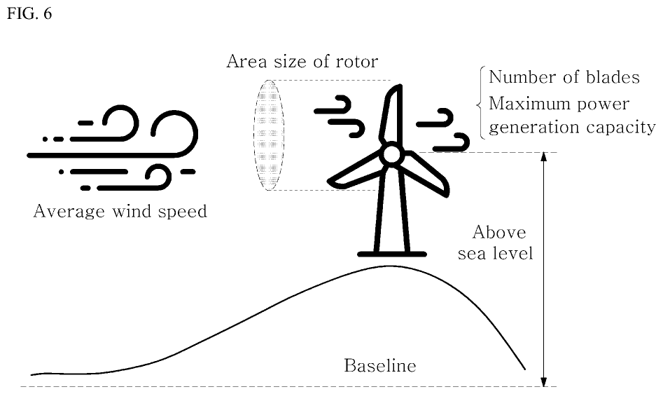

FIG. 6 is a diagram showing a concept of internal and external environmental information of a real-world wind-based power generation facility according to an embodiment of the present disclosure.

As described above, the initial wind speed weight is required to effectuate the device of the present disclosure. Accordingly, in order to use an average value of a final wind speed weight of another real wind-based power generation facility similar to the real-world wind-based power generation facility to which the device of the present disclosure is applied, as the initial wind speed weight, first, another real wind-based power generation facility similar to the real-world wind-based power generation facility to which the device of the present disclosure is applied should be derived.

In this regard, the processor 110 may set an above sea level, an average regional wind speed, a maximum power generation capacity, a number of blades, and a rotor area about the real-world wind-based power generation facility as factors for determining the similarity between another real wind-based power generation facility and the real-world wind-based power generation facility to which the device of the present disclosure.

To this end, the processor 110 may receive first external environmental information regarding the above sea level and an average regional wind speed during a preset period at a location where the first real-world wind-based power generation facility is installed, and may receive first internal environmental information regarding the maximum power generation capacity, the number of blades, and the rotor area size of the first real-world wind-based power generation facility.

In this regard, the preset period may be arbitrarily set by the operator of the device of the present disclosure, and may be set to 1 week, 1 month, etc. In this regard, the average value of the wind speed of the wind blowing toward the real-world wind-based power generation facility may be set as the average regional wind speed.

Moreover, the processor 110 may receive second external environment information and second internal environment information related to a second real-world wind-based power generation facility other than the first real-world wind-based power generation facility, and may compare the first and second external environment information with each other and the first and second internal environment information with each other, and may derive a similarity between the first real-world wind-based power generation facility and the second real-world wind-based power generation facility based on the comparing result.

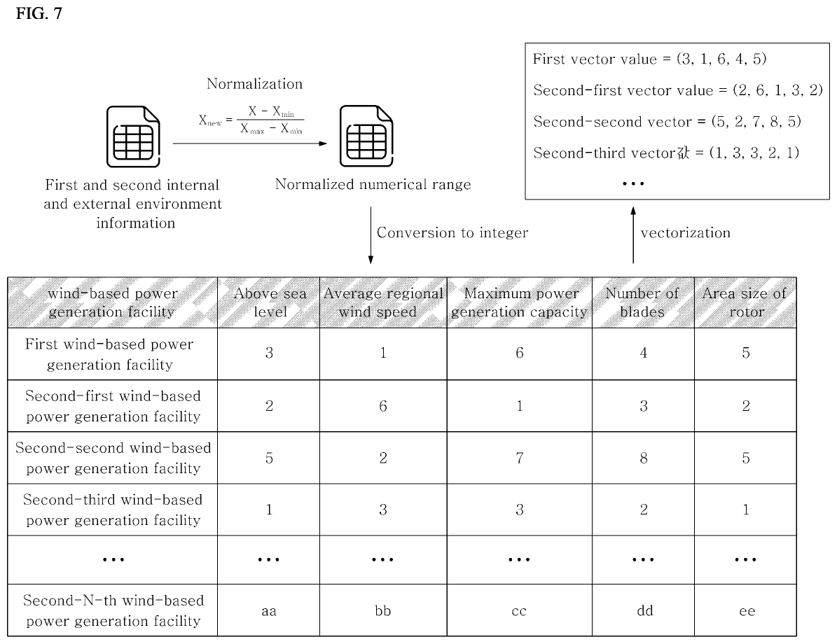

FIG. 7 is a diagram showing derivation of a vector value for determining a similarity according to an embodiment of the present disclosure.

Referring to FIG. 7, the processor 110 may normalize each of the factors included in the first external environment information, the first internal environment information, the second external environment information, and the second internal environment information to a preset numerical range.

In this regard, the preset numerical range may be set to a range that includes a plurality of integers, such as ‘0 to 5’ or ‘0 to 10’, for conversion to an integer to be described later.

Moreover, the processor 110 may round the normalized value of each factor to convert the same into an integer.

Moreover, the processor 110 may generate a first vector value based on the integer value of each factor of the first real-world wind-based power generation facility, and may generate a second vector value based on the integer value of each factor of the second real-world wind-based power generation facility.

Referring to an example in FIG. 7, the first vector value may be set to (3, 1, 6, 4, 5).

Moreover, the processor 110 may derive the similarity based on the first vector value and the second vector value.

In more detail, the similarity may be calculated based on following Mathematical Equation 4:

$$Similarity = \frac{{\sum }_{i = 1}^{k} ( VV1\_i \cdot VV2\_i )}{\sqrt{{\sum }_{i = 1}^{k} {VV1\_i}^{2}} \cdot \sqrt{{\sum }_{i = 1}^{k} VV 2 {\_i}^{2}}} \qquad [ Mathematical Equation 4 ]$$

where VV (Vector Value)1_i refers to an integer value of an i-th factor in the first vector value, VV2_i means an integer value of an i-th factor in the second vector value, and k means the number of factors.

According to the above-described example, k may be set to 5.

In this regard, the processor 110 may compare the calculated similarity with a preset threshold similarity and may derive a third real-world wind-based power generation facility having a similarity exceeding the threshold similarity, and may derive the initial wind speed weight to be initially applied as an average value of the second final wind speed weight of the third real-world wind-based power generation facility.

In this regard, the threshold similarity may be set as an average value of the similarity values respectively between the first real-world wind-based power generation facility and a plurality of second real wind-based power generation facilities.

In this manner, the initial wind speed weight to be initially applied for implementation of the device of the present disclosure may be derived.

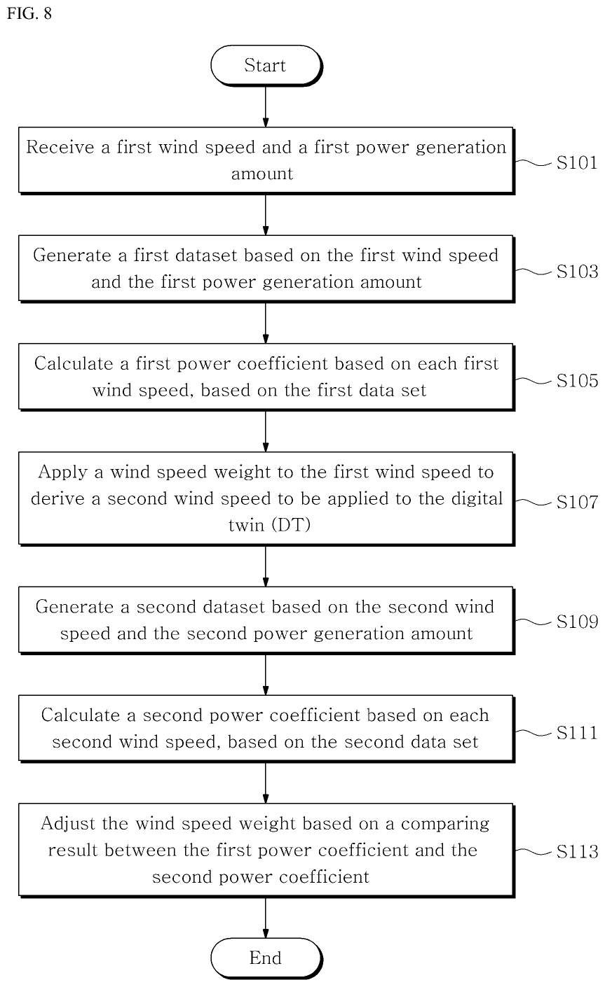

FIG. 8 is a flowchart of a method for controlling a wind speed parameter of a wind-based power generation facility according to an embodiment of the present disclosure.

Referring to FIG. 8, the method for controlling the wind speed parameter of the wind-based power generation facility according to an embodiment of the present disclosure may receive a first wind speed corresponding to an average wind speed per a preset time interval from a first real-world wind-based power generation facility installed in a real world, and receive therefrom a first power generation amount as generated per the preset time interval in S101.

Moreover, the method for controlling the wind speed parameter of the wind-based power generation facility according to an embodiment of the present disclosure may generate a first dataset representing a power generation amount based on a change in a wind speed, based on the first wind speed and the first power generation amount in S103.

Moreover, the method for controlling the wind speed parameter of the wind-based power generation facility according to an embodiment of the present disclosure may calculate a first power coefficient related to the first power generation amount based on each first wind speed, based on the first data set in S105.

Moreover, the method for controlling the wind speed parameter of the wind-based power generation facility according to an embodiment of the present disclosure may apply a wind speed weight to which the initial wind speed weight has been applied to the first wind speed to derive a second wind speed to be applied to the digital twin (DT) in S107.

Moreover, the method for controlling the wind speed parameter of the wind-based power generation facility according to an embodiment of the present disclosure may apply the second wind speed to a DT-based wind-based power generation facility model implemented using the digital twin (DT) to derive a second power generation amount based on the second wind speed, and then generate a second dataset representing a power generation amount based on a change in a wind speed, based on the second wind speed and the second power generation amount in S109.

Moreover, the method for controlling the wind speed parameter of the wind-based power generation facility according to an embodiment of the present disclosure may calculate a second power coefficient related to the second power generation amount based on each second wind speed, based on the second data set in S111.

Moreover, the method for controlling the wind speed parameter of the wind-based power generation facility according to an embodiment of the present disclosure may adjust the wind speed weight based on a comparing result between the first power coefficient and the second power coefficient in S113.

Moreover, the method for controlling the wind speed parameter of the wind-based power generation facility according to an embodiment of the present disclosure may be configured in an identical manner to the device for controlling the wind speed parameter of the wind-based power generation facility disclosed in FIGS. 1 to 7.

The embodiments described above may be implemented with hardware components, software components, and/or a combination of hardware components and software components. For example, the devices, methods, and components described in the embodiments may be implemented using, for example, a processor, a controller, an arithmetic logic unit (ALU), a digital signal processor, a microcomputer, and a field programmable gate (FPGA). array), PLU (programmable logic unit), or a microprocessor or one or more general-purpose or special-purpose computers such as any other device capable of executing and responding to instructions. The processing device may run an operating system (OS) and one or more software applications running on the operating system. Moreover, the processing device may access, store, manipulate, treat, and generate data in response to the execution of software. For ease of understanding, the processing device is described as being used as a single processing device, but those skilled in the art will understand that the processing device may include a plurality of processing elements and/or a plurality of types of processing elements. For example, the processing device may include a plurality of processors or one processor and one controller. Moreover, other processing configurations, such as parallel processors may be available.

The method according to the embodiment may be implemented in the form of program instructions that may be executed through various computer means and thus may be recorded on a computer-readable medium. The computer-readable medium may store therein program instructions, data files, data structures, etc., singly or in combination with each other. The program instructions recorded on the medium may be specially designed and configured so as to be adapted to the embodiment or may be known and available to those skilled in the art of computer software. Examples of the computer-readable recording media may include hardware devices specially configured to store therein and execute the program instructions, such as magnetic media such as hard disks, floppy disks, and magnetic tapes, optical media such as CD-ROMs and DVDs, magneto-optical media such as floptical disks, ROM, RAM, flash memory, etc. Examples of the program instructions include not only machine language code such as that created by a compiler, but also high-level language code that may be executed by a computer using an interpreter, etc. The hardware devices described above may be configured to operate as one or more software modules to perform the operations of the embodiments, and vice versa.

The software may include a computer program, code, instructions, or a combination of one or more thereof and may configure the processing device to operate as desired or may command the processing device independently or collectively. The software and/or data may be permanently or temporarily embodied in any type of machine, component, physical device, virtual device, computer storage medium or device, or transmitted signal wave so as to be interpreted by the processing device or to provide commands or data to the processing device. The software may be distributed over a networked computer system or may be stored or executed in a distributed manner. The software and data may be stored on one or more computer-readable recording media.

Although, as described above, the embodiments are described with limited drawings, those skilled in the art may apply various technical modifications and variations based on the above descriptions. For example, appropriate results may be achieved even when the described steps or operations are performed in a different order from the described order, and/or the components, structures, devices, circuits, etc. of the system as described above are combined with each other in a different manner from the described manner, or are substituted or substituted with other elements or equivalents.

Therefore, other implementations, other embodiments, and equivalents to the claims also fall within the scope of the following claims.

What is claimed is:

1. An electronic device comprising:
a memory; and
a processor connected to the memory,
wherein the processor is configured to:
receive a first wind speed corresponding to an average wind speed per a preset time interval from a first real-world wind-based power generation facility installed in a real world, and receive therefrom a first power generation amount as generated per the preset time interval;
generate a first dataset representing a power generation amount based on a change in a wind speed, based on the first wind speed and the first power generation amount;
calculate a first power coefficient related to the first power generation amount based on each first wind speed, based on the first data set;
derive an initial wind speed weight based on a digital twin (DT) of another real-world wind-based power generation facility having similar external and internal environments to external and internal environments of the first real-world wind-based power generation facility;
apply a wind speed weight to which the initial wind speed weight has been applied to the first wind speed to derive a second wind speed to be applied to the digital twin (DT);
apply the second wind speed to a DT-based wind-based power generation facility model implemented using the digital twin (DT) to derive a second power generation amount based on the second wind speed, and then generate a second dataset representing a power generation amount based on a change in a wind speed, based on the second wind speed and the second power generation amount;
calculate a second power coefficient related to the second power generation amount based on each second wind speed, based on the second data set; and
adjust the wind speed weight based on a comparing result between the first power coefficient and the second power coefficient,
wherein the process is further configured to:
receive first external environmental information regarding an above sea level and an average regional wind speed during a preset period at a location where the first real-world wind-based power generation facility is installed;
receive first internal environmental information regarding a maximum power generation capacity, a number of blades, and a rotor area size of the first real-world wind-based power generation facility;
receive second external environmental information regarding an above sea level and an average regional wind speed during a preset period at a location where a second real-world wind-based power generation facility other than the first real-world wind-based power generation facility is installed;
receive second internal environmental information regarding a maximum power generation capacity, a number of blades, and a rotor area size of the second real-world wind-based power generation facility;
compare the first and second external environment information with each other and the first and second internal environment information with each other;
derive a similarity between the first real-world wind-based power generation facility and the second real-world wind-based power generation facility based on the comparing result;
compare the derived similarity with a preset threshold similarity and derive a third real-world wind-based power generation facility having a similarity exceeding the threshold similarity; and
derive the initial wind speed weight to be initially applied as an average value of a second final wind speed weight of the third real-world wind-based power generation facility.

2. The electronic device of claim 1, wherein the processor is configured to derive the second wind speed by applying the wind speed weight and a vertical component of the wind speed to the first wind speed.

3. The electronic device of claim 2, wherein the second wind speed is derived based on a following Mathematical Equation:
$$WS\_ 2 = WS\_ 1 \times ( 1 + \frac{\vert cos ( θ ) \vert}{WoWS} ) \qquad [ Mathematical Equation ]$$
where WS (Wind Speed)_2 means the second wind speed, WS_1 means the first wind speed, θ means an angle of a wind direction of the first wind speed relative to a preset wind receiving direction of the wind-based power generation facility, and WoWS (Weight of Wind Speed) means the wind speed weight.

4. The electronic device of claim 3, wherein the processor is configured to:
derive a first maximum power coefficient with a highest value from among the first power coefficients derived respectively based on the first wind speeds;
derive a second maximum power coefficient with a highest value from among the second power coefficients derived respectively based on the second wind speeds; and
derive a wind speed weight at which the first maximum power coefficient and the second maximum power coefficient are equal to each other as a first final wind speed weight.
